(19) United States
(12) Patent Application Publication
(10) Pub. No.: US 2005/0108749 A1
(43) Pub. Date: May 19, 2005

(54) Automatic content display apparatus and method

(75) Inventors: Yuko Nishikawa, La Jolla, CA (US); Dayan Golden, San Diego, CA (US); Michael A. Bergeron, Poway, CA (US); Himgan Wibisono, San Francisco, CA (US); Philip McKay, San Francisco, CA (US)

Correspondence Address: FITCH EVEN TABIN & FLANNERY, 120 SOUTH LASALLE SUITE 1600, CHICAGO, IL, 60603, US

(73) Assignees: Sony Corporation, a Japanese corporation, Tokyo (JP); Sony Electronics Inc., a Delaware corporation, Park Ridge, NJ (US)

(21) Appl. No.: 10/806,712

(22) Filed: Mar. 23, 2004

Related U.S. Application Data
(60) Provisional application No. 60/520,752, filed on Nov. 17, 2003.

(51) Int. Cl. H04N 7/173; G06F 13/00; H04N 5/445; H04N 7/20

(52) U.S. Cl. 725/38; 725/73; 725/13

(57) ABSTRACT

Discrete indicators as correspond to various content options are displayed. These discrete indicators move with respect to a segregated display area. When a predetermined orientation exists as between the segregated display area and one of the discrete indicators, additional content as pertains to the content option that corresponds to that particular discrete indicator is automatically displayed.

### PROVISIONAL APPLICATIONS

We claim the benefit of Provisional Patent Application No. 60/520,752, entitled “Ring Interface for TV Programming Guide” and as filed on Nov. 17, 2003.

### RELATED APPLICATIONS

This application relates to each of the following applications, each of which is commonly owned and was filed on an even date herewith and each of which is hereby incorporated by this reference:
3 DIMENSIONAL BROWSING AND SELECTION APPARATUS AND METHOD (attorney's docket number 81231);
INTERACTIVE PROGRAM GUIDE WITH PREFERRED ITEMS LIST APPARATUS AND METHOD (attorney's docket number 81233);
DISPLAY FILTER CRITERIA AND RESULTS DISPLAY APPARATUS AND METHOD (attorney's docket number 81229);
FILTER CRITERIA AND RESULTS DISPLAY APPARATUS AND METHOD (attorney's docket number 81205);
CANDIDATE DATA SELECTION AND DISPLAY APPARATUS AND METHOD (attorney's docket number 81229);
MULTI-SOURCE PROGRAMMING GUIDE APPARATUS AND METHOD (attorney's docket number 81235).

### TECHNICAL FIELD

This invention relates generally to information displays and more particularly to the automatic presentation of information.

### BACKGROUND

Information displays of various kinds are essentially ubiquitous in modern society. Many such displays serve, at least in part, to present content options to a viewer. As the number, kind, and constitution of such content options expand, a concurrent challenge arises to present such options in a manner that is helpful and meaningful to the viewer.

Interactive programming guides are an example of such challenges. With cable, fiber, and/or satellite broadband services facilitating the delivery of an increasing number of varied programming options at any given time, it becomes more important to present a viewer with useful and helpful interface mechanisms to permit the viewer to be informed regarding available content options as the sheer magnitude of programming options renders unlikely the possibility that the viewer will be otherwise sufficiently knowledgeable in this regard.

Present suggestions regarding interactive programming guides as used with various audio/visual content services often present a number of candidate programming options on a display. In some cases this display will include a short textual description of the content of one or more of the candidate programming options or other static information (such as a rating, a brief listing of key actors, a year of publication, and the like). In many cases such displays consume most or all available display room and in any event often render it difficult or impossible to view a presently selected programming option. Furthermore, for many viewers, such information may be insufficiently helpful to facilitate an informed decision regarding the programming option.

### BRIEF DESCRIPTION OF THE DRAWINGS

The above needs are at least partially met through provision of the automatic content display apparatus and method described in the following detailed description, particularly when studied in conjunction with the drawings, wherein:

FIG. 1 comprises a block diagram as configured in accordance with various embodiments of the invention;

FIG. 2 comprises a flow diagram as configured in accordance with various embodiments of the invention;

FIG. 3 comprises a flow diagram as configured in accordance with various embodiments of the invention;

FIG. 4 comprises a display as configured in accordance with various embodiments of the invention;

FIG. 5 comprises a display as configured in accordance with various embodiments of the invention;

FIG. 6 comprises a display as configured in accordance with various embodiments of the invention;

FIG. 7 comprises a display as configured in accordance with various embodiments of the invention; and

FIG. 8 comprises a flow diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is usually accorded to such terms and expressions by those skilled in the corresponding respective areas of inquiry and study except where other specific meanings have otherwise been set forth herein.

### DETAILED DESCRIPTION

Generally speaking, pursuant to these various embodiments, characterizing descriptors as individually correspond to a plurality of discrete selectable items of data are provided. A plurality of discrete indicators for at least some of the discrete selectable items of data are then simultaneously provided on a display. In a preferred embodiment the discrete indicators comprise at least a portion of the characterizing descriptors. In a preferred embodiment the display also includes a segregated display area. Relative movement then automatically occurs as between the plurality of discrete indicators and the segregated display area. When a given one of the discrete indicators interacts in a predetermined way, at least in part, with the segregated display area additional content is automatically displayed. In a preferred approach, the additional content corresponds to the characterizing descriptors for the given one of the discrete indicators.

In a preferred embodiment the characterizing descriptors comprise any of a variety of descriptors as may be relevant to a variety of audio/visual programs. The discrete indicators may comprise one or more of these descriptors or can comprise an alternative device as may be desired in a given application. In a preferred embodiment, the automated provision of additional content occurs when a given one of the discrete indicators coincides in space with the segregated display area. The additional content itself can comprise, for example, exemplary video that is representative of the selected item of data to which the discrete indicator corresponds.

So configured, a viewer can be apprised of alternative (or upcoming) viewing options even while presently engaged in viewing a program of interest. Some relatively small amount of descriptive information can be simultaneously provided for a plurality of candidate programming options with additional content being provided automatically for specific options as coincide with the segregated display area. Such additional content can serve to considerably supplement the information otherwise available to the viewer. In a preferred configuration these benefits are attained without requiring specific ongoing interactions or interventions on the part of the viewer.

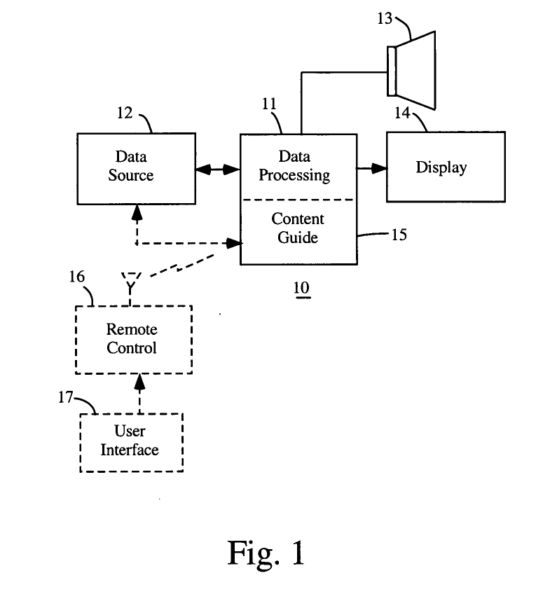

Referring now to the drawings, and in particular to FIG. 1, an apparatus 10 suitable to support and facilitate these teachings can comprise a data processing unit 11 that processes information from a data source 12 (or sources) and provides corresponding audio information to an audio processing path 13 and video information to a display 14.

The control circuitry of the data processing unit 11 can be embodied in a variety of ways. For example, the data processing unit 11 can comprise a fixed-purpose dedicated platform or can comprise a partially or fully programmable platform. Such options and architectural alternatives are well understood in the art and need no further elaboration here. In some embodiments, as with a so-called cable or satellite set-top box, the data processing unit 11 can be readily realized through appropriate programming of the processor as typically accompanies such an apparatus.

The data source 12 can comprise any presently known or hereafter developed data source. In a preferred embodiment the data source 12 provides audio/visual content such as television programs and movies. The data source 12 can provide access to wireless broadcast reception services, cable or optical fiber services, and/or satellite services, to name a few (either alone or in conjunction with one another). Depending upon the needs of the application, it is also possible that the data source 12 provides access to discrete selectable items of audio/visual content as are embodied in a plurality of media. For example, the data source 12 may provide access to cable programming options, satellite programming options, and local programming options as may be available via one or more local or otherwise available media drives (such as but not limited to video tape drives or digital video disk (DVD) drives). It is also possible that the data processing unit 11 operably couples to a plurality of such data sources to permit access to corresponding programming services and viewing options.

In a preferred embodiment this apparatus 10 further comprises a content guide 15. This content guide 15 can comprise an integral part of the data processing unit 11 (as suggested by the illustration in FIG. 1) or can comprise a physically separate platform that operably couples to the data processing unit 11. The content guide 15 can receive information regarding programming options in any of a variety of ways. For example, the data source 12 itself can source such information (either via the data processing unit 11 or directly via a dedicated coupling between itself and the content guide 15 engine). As another example, the content guide 15 can obtain such programming information in other ways such as via a dial-up link (not shown) that facilitates access to a server that provides such information.

Such content guides are generally well understood in the art. In addition, the particular configuration and/or general operation of such engines is not especially important to these embodiments. Therefore additional detailed description will not be provided here regarding content guides except where appropriate below with respect to the description of these embodiments.

It will be understood that such apparatus 10 are often at least partially responsive to an optional wireless remote control 16. The latter often use infrared technology to facilitate communications but any wireless technology as may be appropriate to the needs of a given application can be utilized. In many instances such a remote control 16 will include a user interface 17 such as, for example, a keypad. Such a keypad will provide one or more keys that, when asserted by a user, will cause transmission of a particular corresponding wireless instruction by the remote control 16. Pursuant to a preferred embodiment, the operations of the content guide 15 will be at least partially configurable and/or otherwise controllable by appropriate remote control signals. Again, such remote controls are well understood in the art and require no further elaboration here.

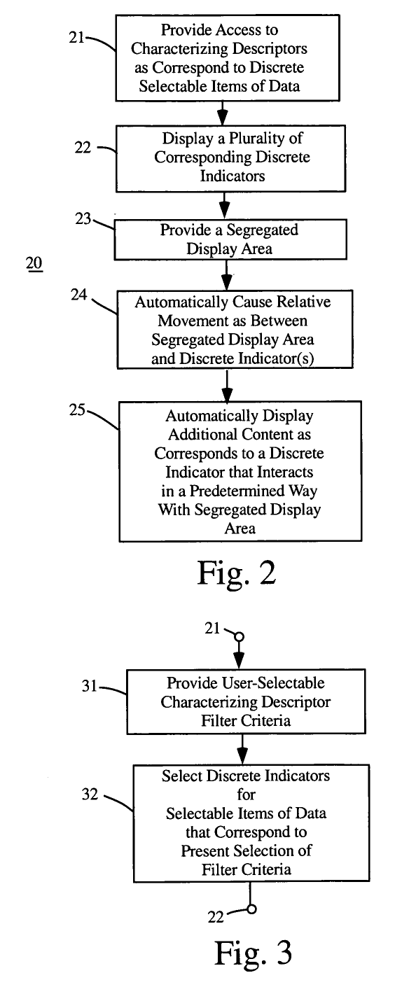

Referring now to FIG. 2, a process 20 that is readily supported by such an apparatus 10 (or that can be alternatively effected through any other suitable architectural configuration of choice) will be described. This process 20 provides for access 21 to characterizing descriptors as individually correspond to a plurality of discrete selectable items of data. In a preferred embodiment these discrete selectable items of data comprise items having audio/visual content (such as individual movies or television programs). The characterizing descriptors for such items of audio/visual content can be many and varied and can include, for example, a programming network identifier (such as the network call sign that will broadcast or otherwise source the particular program), a broadcast starting time (or stopping time) for the program, a description (such as a textual description) of (or that otherwise pertains to) the audio/visual work, and an indication of the content media source itself (such as whether the program is available by cable, satellite, local media, or the like).

This process 20 then provides for the simultaneous display 22 of a plurality of discrete indicators for at least some of these discrete selectable items of data. These discrete indicators can themselves comprise a subset of the characterizing descriptors as may be provided for a given programming option. For example, a given discrete indicator may comprise a content title or genre indication as may properly characterize a given selectable item of data. These discrete indicators can be displayed as appropriate to meet the requirements of a given application, but in a preferred embodiment are disposed at or near the bottom edge of the display (for example, in that portion of a display where a so-called information crawl will often be featured). If desired, of course, only a single such discrete indicator might be displayed at a given time, but in general it is preferred to display a plurality of such indicators. When there are more discrete indicators than can be readily accommodated at once on the display, these discrete indicators are preferably displayed in some kind of rotating fashion. For example, these indicators can slowly move across the bottom of the display, with new indicators entering on one side of the display as other indicators appear to move off the display on the opposing side.

At this point it may be noted that all available candidate discrete indicators can be so displayed. Or, if desired, some selected subset of discrete indicators may be displayed instead. For example, and referring momentarily to FIG. 3, a plurality of user-selectable characterizing descriptor filter criteria can be provided 31 and then used to select 32 a particular set of discrete indicators as correspond to the present selection of such filter criteria. This filter criteria can be varied as appropriate to meet the needs of a given application. As but one example, the filter criteria can specify a time frame such that only programming options as correspond to programs (or program genres) that were recently viewed by the viewer are selected for display as described above. So configured, the use of one or more such filters can be used to limit in some relevant and useful way the collection of candidate programming options as are to be displayed to the viewer pursuant to these teachings.

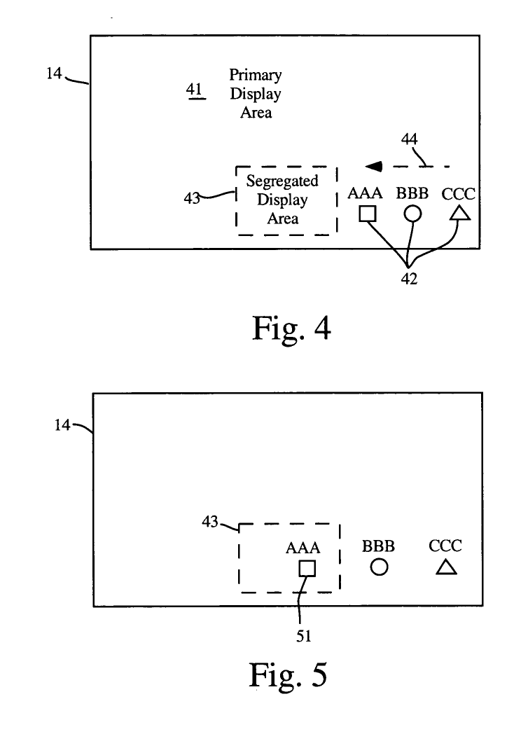

Referring again to FIG. 2, the process 20 provides 23 for a segregated display area on the display. Referring momentarily to FIG. 4, it can be seen that a given display 14 having a primary display area 41 can have a small segregated display area 43 as well. The primary display area 41 can be used, for example, to display a presently selected programming option (such as a given television program, movie, or other audio/visual feature). The segregated display area 43 can comprise, for example, a square or rectangular area (or other shape as may be desired) that is centrally located, in this embodiment, near the bottom of the display. In a preferred embodiment, this segregated display area 43 does not necessarily itself present any obvious indicia regarding its existence. That is, except when functioning as described below, the segregated display area 43 may be transparent to permit the primary display area 41 to appear therethrough.

In a preferred embodiment, the segregated display area 43 is disposed in the path of the discrete indicators 42 as are moving (as denoted by the phantom arrow 44) on the display in accord with the description provided above. So disposed, the discrete indicators 42 will each eventually move into the segregated display area 43.

If desired, precise placement of the segregated display area 43 may be effected by a viewer (using, for example, arrow keys on a remote control in accord with well understood prior art technique). Such placement may be constrained if desired (for example, movement of the segregated display area 43 may only be permitted within a specific area of the display) or unconstrained (such that a viewer might be able to move the segregated display area 43 to essentially anywhere on the display).

So configured, and referring again to FIG. 2, the process 20 effects automatic relative movement 24 as between this segregated display area 43 and the discrete indicators 42. As already noted above, in a preferred approach the former is stationary and the latter move laterally in a marquee crawl fashion across the bottom of the display. Other possibilities exist, of course. For example, the discrete indicators 42 could be stationary (or largely stationary) while the segregated display area 43 could move (continuously or in hops or jumps) with respect to the indicators.

During the course of such movement, the process 20 then provides for automatic display 25 of additional content as corresponds to a given one of the discrete indicators as interacts in a predetermined way (at least in part) with the segregated display area 43. For example, and referring momentarily to FIG. 5, a first one 51 of the discrete indicators can move into the segregated display area 43 and this nexus of positioning with respect to these two display elements can comprise the requisite trigger to cause the automatic display of additional content. Such automatic display of additional content can begin when the discrete indicator first contacts any part of the segregated display area 43 or can be more narrowly constrained (for example, it may be required that all or some minimal percentage of the discrete indicator be within the confines of the segregated display area 43).

Similarly, the automated display of additional content can persist until some subsequent predetermined trigger event. For example, the automated display can continue until the triggering discrete indicator moves out (fully or to some predetermined extent) of the segregated display area 43. Another option is to have the automated display continue until a next discrete indicator triggers its own automated display of corresponding additional content. Yet another illustrative example is to continue the display of additional content until a predetermined period of time expires. These and other options can be employed, alone or in combination with one another, as may best suit the needs of a given application.

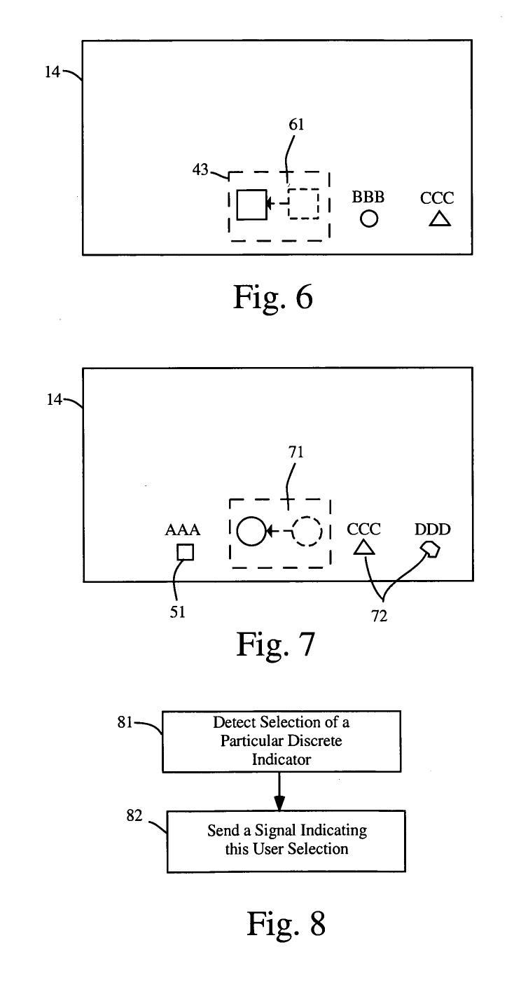

To illustrate, and referring now to FIG. 6, when a first discrete indicator engages the segregated display area 43 as described above, the additional content can comprise a display of video content 61 as corresponds to the characterizing descriptors for the given discrete indicator (when, of course, the characterizing descriptors include such video content). So configured, while a viewer watches a presently selected programming option on the main portion of the display, the viewer can also quickly discern and note a small video presentation at the bottom of the display, which video presentation relates to an alternative (or upcoming) programming choice.

As the described process continues, the discrete indicators continue to move across the bottom of the display and in particular continue to move with respect to the segregated display area 43. Eventually the first discrete indicator 51 in this example will leave the periphery of the segregated display area 43 and another discrete indicator will take its place. Referring now to FIG. 7, additional content, such as video content 71, as corresponds to the latter discrete indicator will then be automatically displayed in the segregated display area 43. Meantime, the trailing discrete indicators 72 can continue to move with respect to the segregated display area 43.

So configured, over time, all of the candidate discrete indicators will eventually coincide with the segregated display area 43 and effect an automated display of additional content. A viewer will therefore be able to become better informed regarding alternative, or future, viewing options even while watching a presently selected program of choice. The automated nature of this process aids in ensuring that the viewer will not be unduly encumbered or distracted.

From time to time a viewer may develop an interest in a programming option as may be highlighted via the above processes. When this occurs, and referring now to FIG. 8, such a viewer will preferably be allowed to select a particular one of the plurality of discrete indicators (for example, through appropriate manipulation of a “select” key on a remote control) and to thereby cause a signal to be sent 82 to indicate this selection. This signal can cause any desired and appropriate responsive action. For example, when the selected indicator corresponds to a presently viewing program, this selection event can be used to cause a present display of that program. As another example, when the selected indicator corresponds to a future viewing option, this selection event can be used to cause scheduled displaying of that program. Other options exist, of course, including scheduled automated recording of the selected program.

Such an approach can work well to provide a viewer with considerable information, over time, regarding their present and future viewing options. To a large extent the process is automated and requires little or no interaction on the part of the viewer. To the extent that a viewer desires to interact with the process (for example, to select a program of interest) the manner of interaction is largely intuitive and requires relatively simple navigation and selection actions as versus more complicated selection processes.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. For example, it may be desirable to provide a toggle capability such that a viewer can cause a video presentation (or other supplemental content display) as may presently be offered in the segregated display area to instead occupy the main display area to afford a better view of something that may catch the attention and interest of the viewer.

1. A method comprising:
providing access to characterizing descriptors as individually correspond to a plurality of discrete selectable items of data;
on a display:
simultaneously providing a plurality of discrete indicators for at least some of the discrete selectable items of data, which discrete indicators comprise at least a portion of the characterizing descriptors as corresponds to the discrete selectable items of data;
providing a segregated display area;
automatically causing relative movement as between the segregated display area and the plurality of discrete indicators;
automatically displaying additional content as corresponds to the characterizing descriptors for a given one of the discrete indicators as interacts in a predetermined way, at least in part, with the segregated display area.

2. The method of claim 1 wherein providing access to characterizing descriptors as individually correspond to a plurality of discrete selectable items of data further comprises providing access to textual characterizing descriptors as individually correspond to a plurality of discrete selectable items of data.

3. The method of claim 1 wherein simultaneously providing a plurality of discrete indicators further comprises simultaneously providing a plurality of content titles.

4. The method of claim 1 wherein the plurality of discrete selectable items of data comprises a plurality of discrete selectable items of audio/visual content.

5. The method of claim 4 wherein the characterizing descriptors as individually correspond to a plurality of discrete selectable items of data comprises at least one of:
a programming network identifier;
a broadcast starting time;
a description of the audio/visual content;
content media source.

6. The method of claim 4 wherein the plurality of discrete selectable items of audio/visual content are embodied in a plurality of media.

7. The method of claim 4 wherein automatically displaying additional content as corresponds to the characterizing descriptors for a given one of the discrete indicators as interacts in a predetermined way, at least in part, with the segregated display area comprises automatically displaying video content as corresponds to the characterizing descriptors for the given one of the discrete indicators.

8. The method of claim 4 wherein the plurality of discrete selectable items of audio/visual content comprises recently accessed items of audio/visual content.

9. A method comprising:
providing access to characterizing descriptors as individually correspond to a plurality of discrete selectable items of data;
providing a plurality of user-selectable characterizing descriptor filter criteria;
on a display:
simultaneously providing a plurality of discrete indicators for at least a portion of the discrete selectable items of data as corresponds to a present selection of a characterizing descriptor filter criterion, which discrete indicators comprise at least a portion of the characterizing descriptors as corresponds to the discrete selectable items of data;
providing a segregated display area;
automatically causing relative movement as between the segregated display area and the plurality of discrete indicators;
automatically displaying additional content as corresponds to the characterizing descriptors for a given one of the discrete indicators as interacts in a predetermined way, at least in part, with the segregated display area.

10. The method of claim 9 wherein the plurality of discrete selectable items of data comprise a plurality of discrete selectable items of audio/visual content.

11. The method of claim 10 wherein the plurality of user-selectable characterizing descriptor filter criteria includes at least one of:
recently viewed discrete selectable items of data;
recommended discrete selectable items of data.

12. The method of claim 9 and further comprising:
detecting user selection of a particular one of the plurality of discrete indicators.

13. The method of claim 12 and further comprising:
sending a signal indicating user selection of the particular one of the plurality of discrete indicators.

14. The method of claim 12 and further comprising:
detecting a remote control device signal indicating the user selection of a particular one of the plurality of discrete indicators.

15. An interactive data display system comprising:
characterizing descriptors as individually correspond to a plurality of discrete selectable items of data;
control circuitry that:
displays a plurality of discrete indicators for at least some of the discrete selectable items of data, which discrete indicators comprise at least a portion of the characterizing descriptors as corresponds to the discrete selectable items of data;
provides a segregated display area;
automatically causes relative movement as between the segregated display area and the plurality of discrete indicators;
automatically displays additional content as corresponds to the characterizing descriptors for a given one of the discrete indicators as interacts in a predetermined way, at least in part, with the segregated display area.

16. The interactive data display system of claim 15 wherein the plurality of discrete selectable items of data comprises a plurality of discrete selectable items of audio/visual content.

17. The interactive data display system of claim 16 wherein the additional content as corresponds to the characterizing descriptors for a given one of the discrete indicators as interacts in a predetermined way, at least in part, with the segregated display area comprises video content.

18. The interactive data display system of claim 15 wherein the control circuitry further:
detects user selection of a particular one of the plurality of discrete indicators.

19. The interactive data display system of claim 18 wherein the control circuitry further:
sends a signal indicating user selection of the particular one of the plurality of discrete indicators.
